(19) United States
(12) Patent Application Publication
(10) Pub. No.: US 2007/0246544 A1
(43) Pub. Date: Oct. 25, 2007

(54) Method for manufacturing memory card structure

(76) Inventors: Sheila Yang, Hsinchu Hsien (TW); Hong Tsu Chang, Hsinchu Hsien (TW); Dennis Pai, Hsinchu Hsien (TW); Frank Lueng, Hsinchu Hsien (TW); Jay Lin, Hsinchu Hsien (TW); Man San Lueng, Hsinchu Hsien (TW); Jerry Lin, Hsinchu Hsien (TW)

Correspondence Address: PRO-TECHTOR INTERNATIONAL SERVICES, 20775 NORADA CT., SARATOGA, CA, 95070, US

(21) Appl. No.: 11/408,481

(22) Filed: Apr. 20, 2006

(51) Int. Cl. G06K 19/06

(52) U.S. Cl. 235/492

(57) ABSTRACT

A method for manufacturing memory card structure comprises the steps of. Providing a carry has an upper surface, which is coated with adhered glue, and a lower surface. Providing a substrate has a first surface, which is formed with first electrodes, and a lower surface, a golden finger is formed on the substrate, and is electrically connected to the first electrodes. Providing a passive component is mounted on the first surface of the substrate. Separating the substrate and the carry. Providing a chip is mounted on the first surface of the substrate. Providing a plurality of wires is electrically connected the chip to the first electrodes of the substrate. Providing a compound resin is covered on the chip and wires.

### BACKGROUND OF THE INVENTION

1. Field of the Invention

The invention relates to a method for manufacturing memory card structure, and particular to a method for packaging memory card, the reliability may be increased.

2. Description of the Related Art

Referring to FIG. 1, a conventional memory card structure includes a substrate 10, an adhered layer 22, a chip 24, wires 28, and a compound layer 30.

The substrate 10 has an upper surface 12, which is formed with first electrodes 16 and golden fingers 18 electrically connected to the first electrodes 16, and passive component 20. The adhered layer 22 is coated on the upper surface 12 of the substrate 10. The chip 24 is formed with bonding pads 26, and is adhered on the upper surface 12 of the substrate 10 by the adhered layer 22. The plurality of wires 28 are electrically connected the bonding pads 26 of the chip 24 to the first electrodes 16 of the substrate 10. And the compound layer 30 is encapsulated on the chip 24 and the wires 28.

### SUMMARY OF THE INVENTION

An objective of the invention is to provide a method for manufacturing memory card structure, and capable of increasing the reliability of the structure.

### SUMMARY OF THE INVENTION

To achieve the above-mentioned object, the invention includes the steps of. Providing a carry has an upper surface, which is coated with adhered glue, and a lower surface. Providing a substrate has first surface, which is formed with a first electrodes, and a lower surface, a golden finger is formed on the substrate, and is electrically connected to the first electrodes. Providing a passive component is mounted on the first surface of the substrate. Separating the substrate and the carry. Providing a chip is mounted on the first surface of the substrate. Providing a plurality of wires is electrically connected the chip to the first electrodes of the substrate. Providing a compound resin is covered on the chip and wires.

### BRIEF DESCRIPTION OF THE DRAWINGS

FIG. 1 is a schematic illustration showing a conventional memory card structure.

FIG. 2 is a first schematic illustration showing a method for manufacturing a memory card structure of the present invention.

FIG. 3 is second schematic illustration showing a method for manufacturing a memory card structure of the present invention.

FIG. 4 is third schematic illustration showing a method for manufacturing a memory card structure of the present invention.

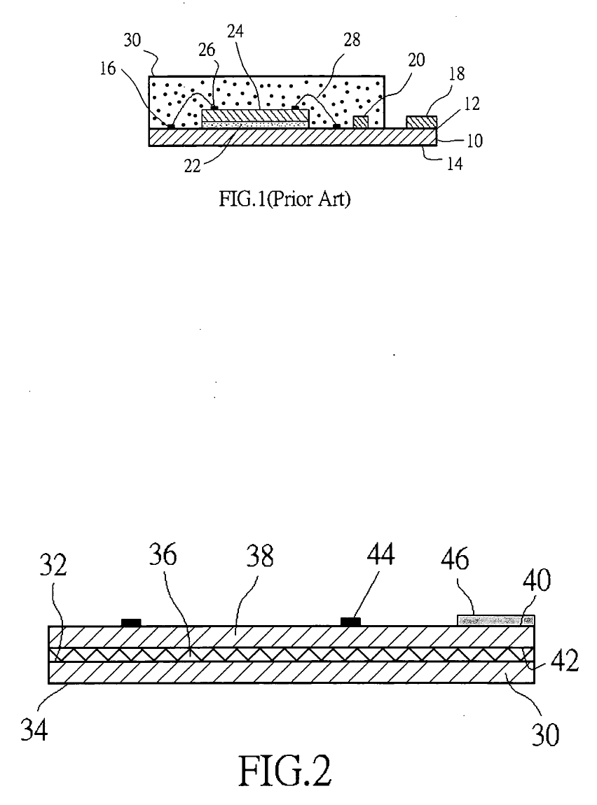

### DETAILED DESCRIPTION OF THE INVENTION

Please refer to FIG. 2, it is first schematic illustration showing a method for manufacturing a memory card structure of the present invention.

Providing a carry 30 has an upper surface 32, which is coated with adhered glue 36, and a lower surface 34. Providing a substrate 38 has a first surface 40, which is formed with first electrodes 44, and a second surface 42, which is adhered to the upper surface 32 of the carry 30, a golden finger 46 is formed on the first surface 40 of the substrate 38, and is electrically connected to the first electrodes 44 of the substrate 38.

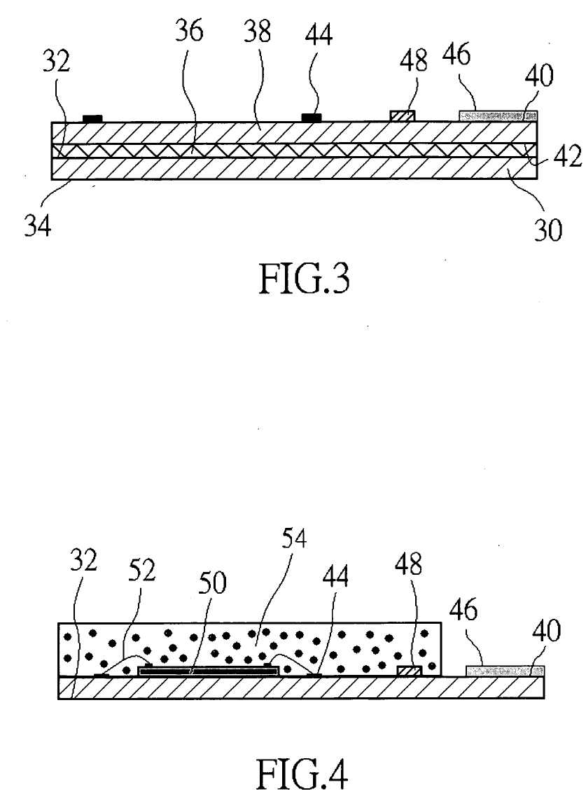

Please refer to FIG. 3, it is second schematic illustration showing a method for manufacturing a memory card structure of the present invention.

Providing a passive component 48 is mounted on the first surface 40 of the substrate 38 by surface mounted technology (SMT).

Please refer to FIG. 4, it is second schematic illustration showing a method for manufacturing a memory card structure of the present invention.

Separating the substrate 38 and the carry 30.

Providing a chip 50, which is mounted on the first surface 40 of the substrate 38.

Providing a plurality of wires 52, which are electrically connected the chip 50 to the first electrodes 44 of the substrate 38; and

Providing a compound resin 54, which is covered on the chip 50 and wires 52.

While the invention has been described by the way of an example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A method for manufacturing memory card structure, comprising the steps of;
Providing a carry having an upper surface, which is coated with adhered glue, and a lower surface;
Providing a substrate having a first surface, which is formed with a first electrodes, and a second surface, which is adhered to the upper surface of the carry, a golden finger is formed on the substrate, and electrically connected to the first electrodes;
Providing a passive component mounted on the first surface of the substrate;
Separating the substrate and the carry;
Providing a chip mounted on the first surface of the substrate;
Providing a plurality of wires electrically connected the chip to the first electrodes of the substrate; and
Providing a compound layer covered on the chip and wires.

2. The method according to claim 1, wherein the golden finger is mounted on the first surface of the substrate

3. The method according to claim 1, wherein the passive compound is mounted on the first surface of the substrate by surface mounted technology (SMT)

4. The method according to claim 1, wherein the compound layer is form of epoxy.
